(19) United States
(12) Patent Application Publication
(10) Pub. No.: US 2015/0326859 A1
(43) Pub. Date: Nov. 12, 2015

(54) VIDEO QUANTIZATION-PARAMETER ENCODING METHOD, VIDEO QUANTIZATION-PARAMETER DECODING METHOD, DEVICE, AND PROGRAM

(71) Applicant: NEC Corporation, Tokyo (JP)

(72) Inventor: Keiichi CHONO, Tokyo (JP)

(21) Appl. No.: 14/410,215

(22) PCT Filed: Jun. 6, 2013
(86) PCT No.: PCT/JP2013/003573

§ 371 Date: Dec. 22, 2014

(30) Foreign Application Priority Data
Jun. 28, 2012 (JP) 2012-145434

(51) Int. Cl. H04N 19/13; H04N 19/593; H04N 19/463; H04N 19/169; H04N 19/126

(52) U.S. Cl. CPC H04N 19/13; H04N 19/1887; H04N 19/126; H04N 19/463; H04N 19/593

(57) ABSTRACT

A video quantization parameter encoding device includes: a prediction unit (11) for generating a predicted quantization parameter from a past reconstructed quantization parameter; a computing unit (12) for generating a delta quantization parameter from a quantization parameter and the predicted quantization parameter; and a quantization parameter encoding unit (13) for generating an exponential Golomb bin string of a value obtained by converting the delta quantization parameter into an unsigned expression, performing adaptive binary arithmetic encoding on a first bin of the exponential Golomb bin string, indicating whether the value of the unsigned expression of the delta quantization parameter is significant, and, when the first bin indicates the value is significant, performing fixed binary arithmetic encoding on other bins of the exponential Golomb bin string.

### TECHNICAL FIELD

The present invention relates to a technology of encoding a video quantization parameter for video encoding using context-based adaptive binary arithmetic coding, for example, a video quantization parameter encoding method, a video quantization parameter decoding method, a video quantization parameter encoding device, a video quantization parameter decoding device, a video quantization parameter encoding program, and a video quantization parameter decoding program, which are adaptively applicable to a video encoding device, a video decoding device, and the like.

### BACKGROUND ART

Non Patent Literatures (NPLs) 1 and 2 each disclose a video encoding technology that uses context-based adaptive binary arithmetic coding (CABAC).

FIG. 9 depicts a block diagram illustrating a configuration of a video quantization parameter encoding device in the video encoding technology using CABAC. The video quantization parameter encoder (hereinafter, referred to as a general video quantization parameter encoder) illustrated in FIG. 9 includes a predictor 101, a buffer 102, a binarizer 1030, an adaptive binary arithmetic encoder 104, and a switch (SW) 111.

A predicted quantization parameter (PQP) supplied from the predictor 101 is subtracted from a quantization parameter (QP) input to the general video quantization parameter encoder. The QP from which the PQP has been subtracted is referred to as a delta quantization parameter (delta QP: DQP).

In NPL 1, the PQP is a reconstructed quantization parameter (Last reconstructed QP: LastRQP) of an image block that is lastly reconstructed. In NPL 2, the PQP is a reconstructed quantization parameter (left reconstructed QP: LeftRQP) of a left adjacent image block or a reconstructed quantization parameter (LastRQP) of a last reconstructed image block.

In order for subsequent quantization parameter encoding, the PQP is added to a DQP and the DQP is stored in the buffer 102 as the reconstructed quantization parameter (RQP).

The binarizer 1030 binarizes the DQP to obtain a bin string. One bit of the bin string is referred to as a bin. In the bin string, a bin that is binary arithmetic encoded first is referred to as a first bin (1^{st} bin), a bin that is binary arithmetic encoded second is referred to as a second bin (2^{nd} bin), and a bin that is binary arithmetic encoded n-th is referred to as a n-th bin (n^{th} bin). The bin and the bin string are defined in 3.9 and 3.12 of NPL 1.

FIG. 10 depicts an explanatory diagram illustrating a correspondence table between the DQP (rightmost column) and the bin string (center column) in NPLs 1 and 2. The bin string of the DQP is an unary binarization of a value obtained by converting the DQP into an unsigned variable UDQP (UDQP=2×|DQP|−(DQP>0? 1:0)). That is, the bin string of the DQP is made up of bins of successive “1”s, the number of which is the UDQP (equal to or greater than 0), and a bin of one “0” (indicating an end).

The bit string index in the leftmost column in FIG. 10 indicates an index of a bit string corresponding to a DQP value. The bin string index is 1 in the case where the DQP is 0, 2×DQP−1 in the case where the DQP is greater than 0, and −2×DQP+1 in the case where the DQP is less than 0. That is, a value of the bin string index is equal to the UDQP.

A context index in the lowermost row in FIG. 10 indicates an index of a context used for binary arithmetic encoding of a bin in a corresponding column. For example, the bin string corresponding to DQP=−1 is 110, in which the value of the first bin is 1, the value of the second bin is 1, and the value of the third bin is 0. The context index used for binary arithmetic encoding of the first bin is 0, the context index used for binary arithmetic encoding of the second bin is 2, and the context index used for binary arithmetic encoding of the third bin is 3. The context is a combination of a most probable symbol (MPS) of the bin and its probability.

The adaptive binary arithmetic encoder 104 binary arithmetic encodes bins of the bin string supplied through the switch 111 from the beginning thereof, by using the context associated with the corresponding context index. The adaptive binary arithmetic encoder 104 also updates the context associated with the context index according to a value of the binary arithmetic encoded bin, for subsequent binary arithmetic encoding. Detailed operations of adaptive binary arithmetic encoding are described in 9.3.4 in NPL 1.

The general quantization parameter encoder encodes an input image quantization parameter according to the above-mentioned operations.

### CITATION LIST

### Non Patent Literature

NPL 1: ISO/IEC 14496-10 Advanced Video Coding, Apr. 26, 2012

NPL 2: “WD3: Working Draft 3 of High-Efficiency Video Coding”, Document: JCTVC-E603, Joint Collaborative Team on Video Coding (JCT-VC) of ITU-T SG16 WP3 and ISO/IEC JTC1/SC29/WG11 5th Meeting: Geneva, CH, 16-23 March, 2011

### SUMMARY OF INVENTION

### Technical Problem

As can be seen from FIG. 10, the general quantization parameter encoder sets, as a bin string, an unary binarization of a value obtained by converting a DQP into an unsigned variable UDQP and adaptive binary arithmetic encodes on all bins. Therefore, there is a problem of being unable to suitably encode the significant DQP due to the following two factors.

The first factor is that the number of bins included in a bin string handled by a quantization parameter encoder is approximately twice an absolute value of a DQP. A large number of bins lead to an increase in the number of times of binary arithmetic encoding and a decrease in the speed of DQP encoding process and decoding process.

The second factor is that, since a second bin and subsequent bins include information about three or more states which cannot be expressed by one bit, it is impossible to binary arithmetic encode the bins using appropriate contexts. Information that can be expressed by one bin is information of which one of two states holds true. However, the second bin and the subsequent bins include information about three or more states which cannot be expressed by one bin. In detail, in FIG. 10, the second bin includes information of whether the DQP is positive or negative and information indicating whether the absolute value of the significant DQP is greater than or equal to 1. The subsequent bins from the third bin (in the rows after a 3rd row) include information of whether the DQP is positive or negative and information indicating the magnitude of the absolute value of the significant DQP. Hence, it is impossible to binary arithmetic encode, with appropriate contexts, the second bin and the subsequent bins including information about three or more states which cannot be expressed by one bin.

Therefore, an object of the present invention is to enable appropriate encoding of a video quantization parameter for video encoding that uses context-based adaptive binary arithmetic coding, by resolving each of the above-described factors.

### Solution to Problem

A video quantization parameter encoding method according to the present invention, which encodes a quantization parameter for video encoding processing based on context-based adaptive binary arithmetic encoding, includes: generating a predicted quantization parameter from a past reconstructed quantization parameter; generating a delta quantization parameter from a quantization parameter and the predicted quantization parameter; generating an exponential Golomb bin string of a value obtained by converting the delta quantization parameter into an unsigned expression; adaptive binary arithmetic encoding a first bin of the exponential Golomb bin string, indicating whether the value of the unsigned expression of the delta quantization parameter is significant; and, when the first bin indicates that the value is significant, fixed binary arithmetic encoding other bins of the exponential Golomb bin string.

A video quantization parameter decoding method according to the present invention, which decodes a quantization parameter for video decoding processing based on context-based adaptive binary arithmetic encoding, includes: generating a predicted quantization parameter from a past reconstructed quantization parameter; adaptive binary arithmetic decoding a first bin of an exponential Golomb bin string, indicating whether a value of an unsigned expression of a delta quantization parameter is significant; fixed binary arithmetic decoding other bins of the exponential Golomb bin string when the first bin indicates that the value is significant; converting the unsigned expression of the decoded delta quantization parameter into a value of an original delta quantization parameter.

A video quantization parameter encoding device according to the present invention includes: a prediction unit which generates a predicted quantization parameter from a past reconstructed quantization parameter; a computing unit which generates a delta quantization parameter from a quantization parameter and the predicted quantization parameter; and a quantization parameter encoding unit which generates an exponential Golomb bin string of a value obtained by converting the delta quantization parameter into an unsigned expression, adaptive binary arithmetic encodes a first bin of the exponential Golomb bin string, indicating whether the value of the unsigned expression of the delta quantization parameter is significant, and, when the first bin indicates that the value is significant, fixed binary arithmetic encodes other bins of the exponential Golomb bin string.

A video quantization parameter decoding device according to the present invention includes: a prediction unit for generating a predicted quantization parameter from a past reconstructed quantization parameter; and a quantization parameter decoding unit which adaptive binary arithmetic decodes a first bin of an exponential Golomb bin string, indicating whether a value of an unsigned expression of a delta quantization parameter is significant, fixed binary arithmetic decodes other bins of the exponential Golomb bin string when the first bin indicates that the value is significant, and converts the unsigned expression of the decoded delta quantization parameter into a value of an original delta quantization parameter.

A video quantization parameter encoding program according to the present invention causes a computer to perform: a prediction process of generating a predicted quantization parameter from a past reconstructed quantization parameter; a computing process of generating a delta quantization parameter from a quantization parameter and the predicted quantization parameter; and a quantization parameter encoding process of generating an exponential Golomb bin string of a value obtained by converting the delta quantization parameter into an unsigned expression, adaptive binary arithmetic encoding a first bin of the exponential Golomb bin string, indicating whether the value of the unsigned expression of the delta quantization parameter is significant, and, when the first bin indicates that the value is significant, fixed binary arithmetic encoding other bins of the exponential Golomb bin string.

A video quantization parameter decoding program according to the present invention causes a computer to perform: a prediction process of generating a predicted quantization parameter from a past reconstructed quantization parameter; and a quantization parameter decoding process of adaptive binary arithmetic decoding on a first bin of an exponential Golomb bin string, indicating whether a value of an unsigned expression of a delta quantization parameter is significant, fixed binary arithmetic decoding other bins of the exponential Golomb bin string when the first bin indicates that the value is significant, and converting the unsigned expression of the decoded delta quantization parameter into a value of an original delta quantization parameter.

### Advantageous Effects of Invention

According to the present invention, it is possible to adequately encoding a video quantization parameter of video encoding using context-based adaptive binary arithmetic encoding.

### BRIEF DESCRIPTION OF DRAWINGS

FIG. 1 It depicts a block diagram illustrating a configuration of a video quantization parameter encoder of a first exemplary embodiment.

FIG. 2 It depicts a flowchart illustrating operation of the video quantization parameter encoder of the first exemplary embodiment.

FIG. 3 It depicts an explanatory diagram illustrating an example of a correspondence table between a DQP and a bin string.

FIG. 4 It depicts a block diagram illustrating a configuration of a video quantization parameter encoder of a second exemplary embodiment.

FIG. 5 It depicts a flowchart illustrating operation of the video quantization parameter encoder of the second exemplary embodiment.

FIG. 6 It depicts a block diagram illustrating a configuration example of an information processing system capable of realizing functions of a video quantization parameter encoder and a video quantization parameter decoder according to the present invention.

FIG. 7 It depicts a block diagram illustrating characteristic components in a video quantization parameter encoding device according to the present invention.

FIG. 8 It depicts a block diagram illustrating characteristic components in a video quantization parameter decoding device according to the present invention.

FIG. 9 It depicts a block diagram illustrating a configuration of a general video quantization parameter encoder.

FIG. 10 It depicts an explanatory diagram illustrating a general example of a correspondence table between a DQP and a bin string.

### DESCRIPTION OF EMBODIMENTS

Exemplary embodiments of the present invention will be described below with reference to drawings.

### Exemplary Embodiment 1

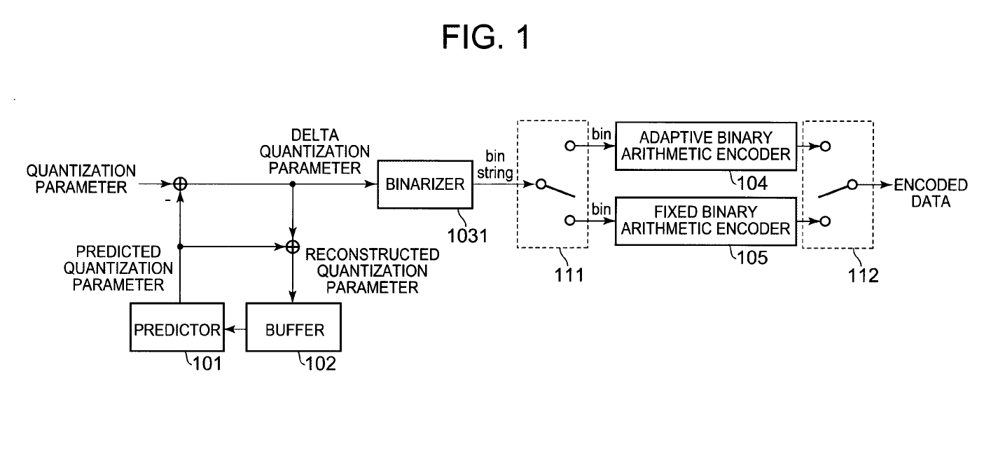

FIG. 1 depicts a block diagram illustrating a configuration of a video quantization parameter encoder of a first exemplary embodiment according to the present invention. The video quantization parameter encoder illustrated in FIG. 1 includes a predictor 101, a buffer 102, a binarizer 1031, an adaptive binary arithmetic encoder 104, a fixed binary arithmetic encoder 105, a switch (SW) 111, and a switch (SW) 112.

The video quantization parameter encoder of the present exemplary embodiment sets a 0-th order exponential Golomb (0th-order Exp-Golomb) binarization of a value obtained by converting a DQP into unsigned variable UDQP as a bin string, adaptive binary arithmetic encodes a first bin of the Exp-Golom bin string indicating whether a value of an unsigned expression of a delta quantization parameter is significant, and fixed binary arithmetic encodes other bins of the Exp-Golom bin string indicating the value of the unsigned expression of the delta quantization parameter. Also, an order of an exponential Golomb may have orders other than 0.

A prefix part of the exponential Golomb binarization is made up of bins of successive “1”s, the number of which is equal to or greater than 0 and one bin of “0” indicating an end. A suffix part is made up of bins of the number N of successive “1”s of the prefix part. The exponential Golomb binarization can express the UDQP by a bin string shorter than the unary binarization according to the exponential expression. Also, details of a K-th order exponential Golomb code are described in 9.3.2.4 of NPL 1.

The fixed binary arithmetic encoding binary arithmetic encodes the bins by using an equal probability. Therefore, the fixed binary arithmetic encoder can binary arithmetic encode a bin, on which binary arithmetic encoding using appropriate context is difficult to be performed, at a fixed compression rate.

Subsequently, content of each block of the present exemplary embodiment will be described.

A predicted quantization parameter PQP supplied from the predictor 101 is subtracted from a quantization parameter (QP) input to the video quantization parameter encoder.

In order for subsequent quantization parameter encoding, the PQP is added to a delta quantization parameter (DQP)(DQP=QP−PQP) and the sum is stored in the buffer 102 as a reconstructed quantization parameter (RQP)(RQP=DQP+PQP).

The binarizer 1301 that is the feature of the present invention converts an input DQP into an unsigned variable UDQP (UDQP=2×|DQP|−(DQP>0?1:0)) and outputs a bin string of a 0-th order exponential Golomb of a value thereof. A first bin of the bin string of the 0-th order exponential Golomb indicates whether the UDQP, that is, the DQP is significant. The other bins of the bin string of the 0-th order exponential Golomb indicates a size of a value of the UDQP, that is, a combination of an absolute value and a sign of the DQP. With respect to the UDQP having a value greater than 0, a value of the absolute value AbsDQP of the DQP is a value obtained by dividing a value resulting from adding 1 to the UDQP by 2 (AbsDQP=(UDQP+1)/2).

(AbsDQP=(UDQP+1)/2). With respect to the UDQP having a value greater 0, the sign SignDQP of the DQP is + when the UDQP is an odd number, and is − when the UDQP is an even number.

The adaptive binary arithmetic encoder 104 binary arithmetic encodes a first bin of the bin string supplied through the switch 111 by using context associated with a context index thereof, and outputs encoded data thereof through the switch 112. Also, in order for subsequent binary arithmetic encoding, the adaptive binary arithmetic encoder 104 updates the context associated with the context index, according to a value of the binary arithmetic encoded bin.

The fixed binary arithmetic encoder 105 binary arithmetic encodes bins subsequent to the first bin of the bin string supplied through the switch 111 at an equal probability and outputs encoded data thereof through the switch 112.

The description of the configuration of the video quantization parameter encoder of the present exemplary embodiment is ended.

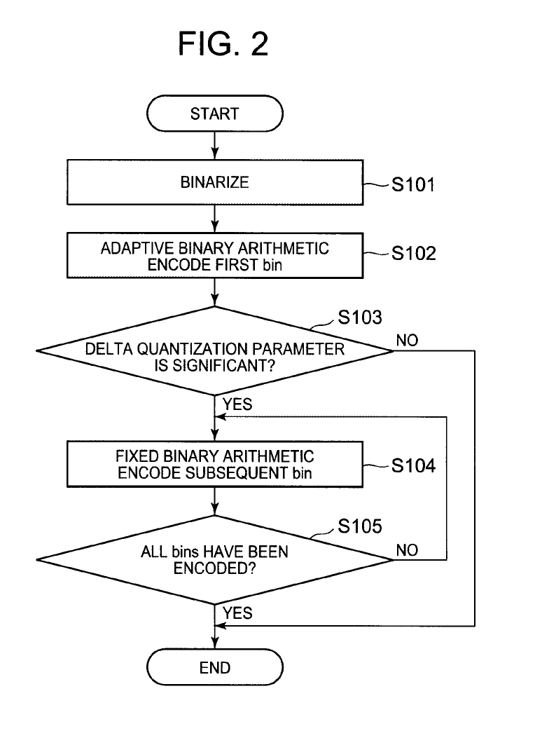

Next, operations of the binarizer 1031, the adaptive binary arithmetic encoder 104, and the fixed binary arithmetic encoder 105 which are features of the video quantization parameter encoder of the present exemplary embodiment will be described with reference to a flowchart of FIG. 2.

The adaptive binary arithmetic encoder 104 starts a process by setting an initial value parameter n to 1.

In step S101, the binarizer 1031 converts an input DQP into an unsigned variable UDQP, and outputs a bin string of a 0-th exponential Golomb of a value thereof.

In step S102, the adaptive binary arithmetic encoder 104 adaptive arithmetic encodes a bin(n). The n is incremented.

In step S103, the fixed binary arithmetic encoder 105 determines whether the DQP is significant. When the DQP is significant, the process proceeds to step S104. Otherwise, the process is ended.

In step S104, the fixed binary arithmetic encoder 105 fixed binary arithmetic encodes the bin(n).

In step S105, the fixed binary arithmetic encoder 105 determines whether all bins of the bin string are encoded. When all bins of the bin string are encoded, the process is ended. Otherwise, the fixed binary arithmetic encoder 105 increments the n and the process proceeds to step S104 in order to perform fixed or adaptive binary arithmetic encoding on a subsequent bin(n).

The description of the operations of the binarizer 1031, the adaptive binary arithmetic encoder 104, and the fixed binary arithmetic encoder 105 which are features of the video quantization parameter encoder of the present exemplary embodiment is ended.

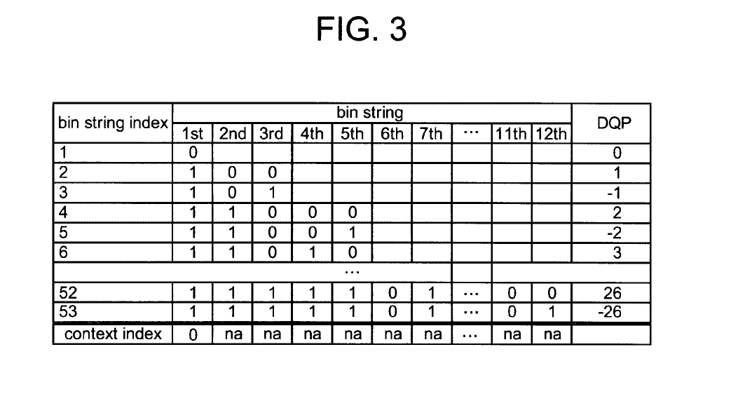

FIG. 3 is an explanatory diagram illustrating an example of a correspondence table between a DQP (rightmost column) and a bin string (center column) in the present invention. Also, a bin string index is equal to a value of a UDQP.

Referring to FIG. 3, in the row of the context index, na indicates that context is not used, that is, an equal probability is used for binary arithmetic.

In the video quantization parameter encoding processing of the present, the two factors in above Technical Problem are resolved as described below.

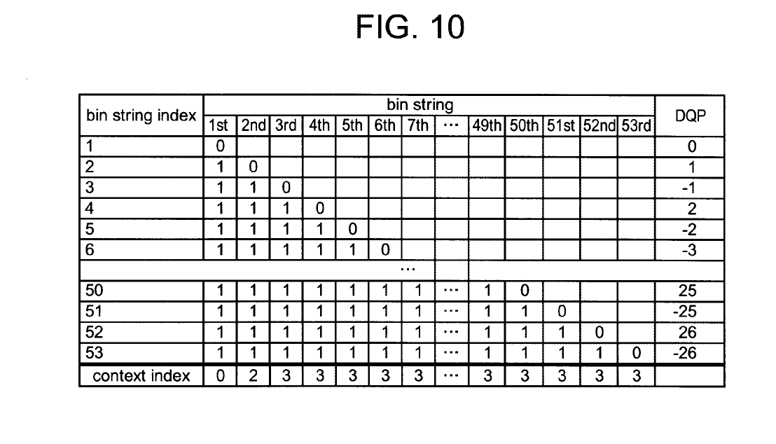

The first factor is resolved by realizing the UDQP with a short bin string by using an exponential Golomb code. Referring to FIG. 3, the number of bins of a bin string is 12 with respect to the UDQP having the largest value. That is, the number of bins is less than ¼ of the number of bins, 53 of the general case illustrated in FIG. 10. It is possible to reduce the number of times of binary arithmetic encoding and increase an encoding processing speed and a decoding processing speed for the DQP by expressing the UDQP using a short bin string.

The second factor is resolved by binary arithmetic encoding, at an equal probability, subsequent bins after a first bin, including information related to three or more states which cannot be expressed by one bin. The bins after the first bin are binary arithmetic encoded at the equal probability, thereby binary arithmetic encoding the bin, on which binary arithmetic encoding using appropriate context is difficult to be performed, at a fixed compression rate with lightness.

### Exemplary Embodiment 2

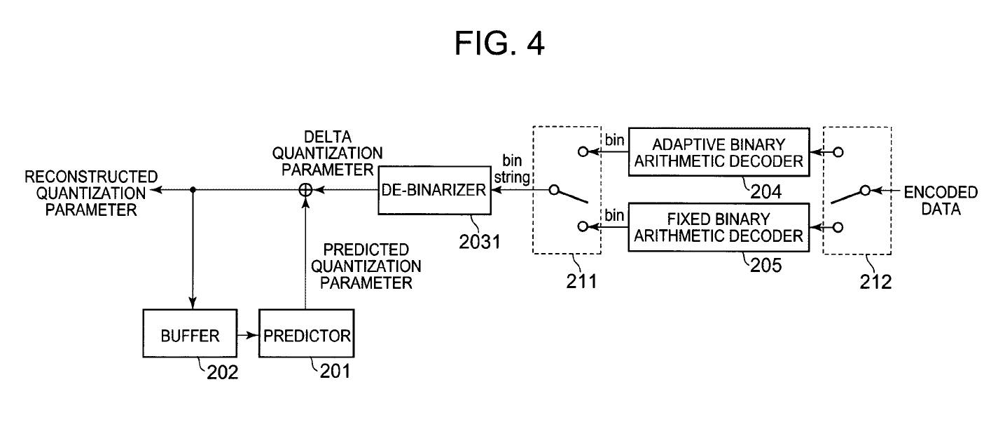

FIG. 4 depicts a block diagram illustrating a configuration of a video quantization parameter decoder corresponding to the video quantization parameter encoder of the first exemplary embodiment. The video quantization parameter decoder illustrated in FIG. 4 includes a predictor 201, a buffer 202, a de-binarizer 2031, an adaptive binary arithmetic decoder 204, a fixed binary arithmetic decoder 205, a switch (SW) 211, and a switch (SW) 212.

The adaptive binary arithmetic decoder 204 binary arithmetic decodes a bin (1) from encoded data supplied through the switch 212 and supplies the bin (1) to the de-binarizer 2031 through the switch 211. Also, in order for subsequent binary arithmetic decoding, the adaptive binary arithmetic decoder 204 updates context associated with a context index corresponding to the first bin, according to a value of the binary arithmetic decoded bin.

When the bin (1) is 1 (when the UDQP is significant), the fixed binary arithmetic decoder 205 binary arithmetic decodes a subsequent bin(n) (n>1) from encoded data supplied through the switch 212, and supplies the bin(n) to the de-binarizer 2031 through the switch 211. Also, a length of a prefix part is a length obtained by adding the bin (1) and 2 of “0” at an end to the number M of successive “1”s which have been fixed binary arithmetic decoded previously. In addition, a length of a suffix part is M+1.

The de-binarizer 2031 determines a bin string index corresponding to a bin string that is made up of outputs of the adaptive binary arithmetic decoder 204 and the fixed binary arithmetic decoder 205, that is, a UDQP.

Subsequently, when the UDQP is 0, the de-binarizer 2031 outputs DQP=0. Otherwise, an absolute value AbsDQP and a sign SignDQP of the DQP are determined. Based on them, the UDQP is converted into an original DQP and the original DQP is output. Also, the AbsDQP is a value obtained by dividing a value resulting from adding 1 to the UDQP by 2. The SignDQP is + when the UDQP is an odd number, and is − when the UDQP is an even number. The DQP is a value obtained by multiplying the SignDQP by the AbsDQP.

A PQP supplied from the predictor 201 is added to the DQP supplied from the de-binarizer 2031, thereby obtaining a RQP.

In addition, the RQP is stored in the buffer 202 in order for subsequent quantization parameter decoding.

The description of the configuration of the video quantization parameter decoder of the present exemplary embodiment is ended.

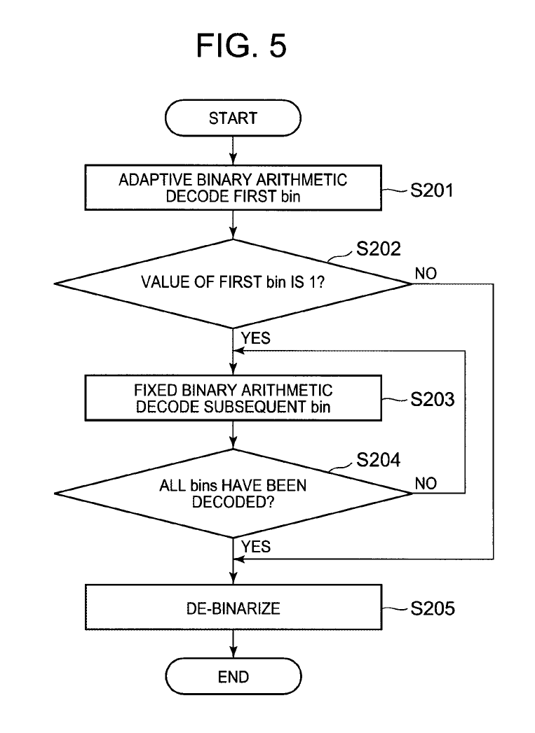

Next, operations of the de-binarizer 2031, the adaptive binary arithmetic decoder 204, and the fixed binary arithmetic decoder 205, which are features of the video quantization parameter decoder of the present exemplary embodiment will be described with reference to a flowchart of FIG. 5.

The adaptive binary arithmetic decoder 204 starts a process by setting an initial value parameter n to 1.

In step S201, the adaptive binary arithmetic decoder 204 adaptive arithmetic decodes a bin(n). The n is incremented.

In step S202, the fixed binary arithmetic decoder 205 determines whether a value of a bin(n−1), that is, a bin(1) is 1. In this example, bin(1)=1 indicates that the UDQP, that is, the DQP is significant. When the value of the bin(1) is 1, the process proceeds to step S203. Otherwise, the process proceeds to step S205.

In step S203, the fixed binary arithmetic decoder 205 fixed binary arithmetic encodes on the bin(n).

In step S204, the fixed binary arithmetic decoder 205 determines whether all bins are decoded, that is, whether a final bin of a fixed portion is decoded. When all bins are decoded, the process proceeds to step S205. Otherwise, the n is incremented and the process proceeds to step S203 in order to perform fixed binary arithmetic decoding on a subsequent bin(n).

In step S205, the de-binarizer 2031 de-binarizes the decoded bin string and determines the DQP.

The description of the operations of the de-binarizer 2031, the adaptive binary arithmetic decoder 204, and the fixed binary arithmetic decoder 205 which are features of the video quantization parameter decoder of the present exemplary embodiment is ended.

Also, although the above exemplary embodiments can be configured by hardware, it is possible to realize the above exemplary embodiments by a computer program.

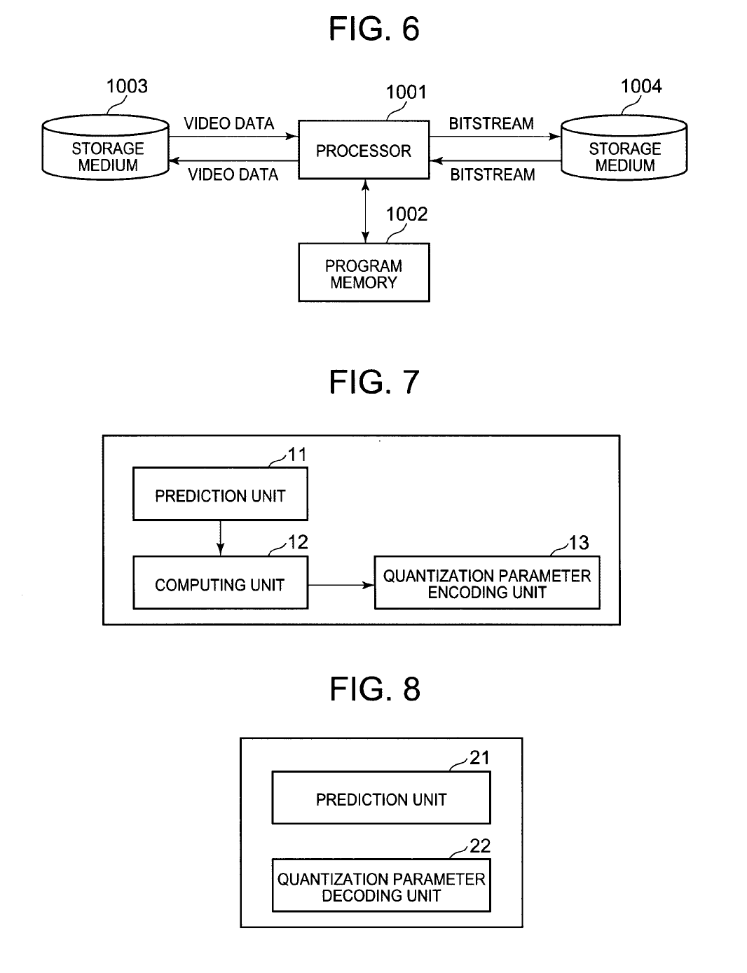

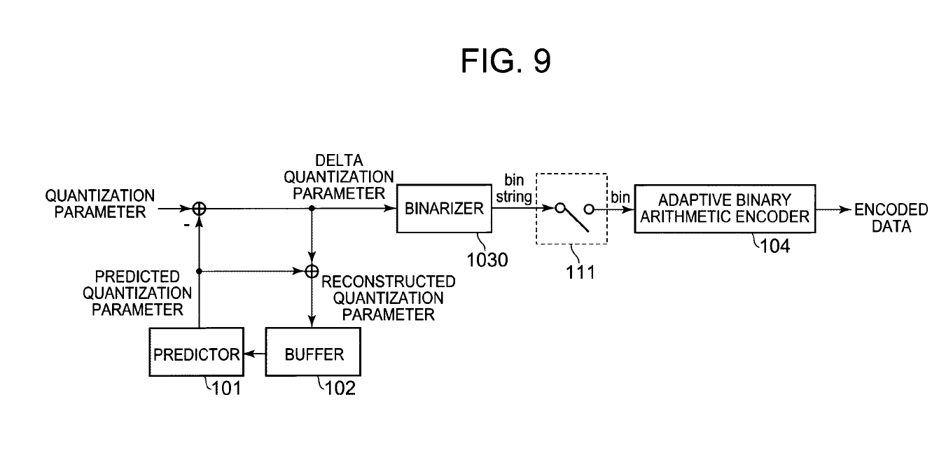

An information processing system illustrated in FIG. 6 includes a processor 1001, a program memory 1002, a recoding medium 1003 for storing video data, and a recoding medium 1004 for storing a bitstream. The recording media 1003 and 1004 may be separate storage media or may be storage areas configured by the same storage medium. As the storage medium, a magnetic storage medium, such as a hard disk, can be used.

In the information processing system illustrated in FIG. 6, the program memory 1002 stores programs for realizing functions of the respective blocks (but, excluding a buffer block) illustrated in FIG. 1 and FIG. 4. In addition, the processor 1001 realizes functions of the video quantization parameter encoder or the video quantization parameter decoder respectively illustrated in FIG. 1 and FIG. 4 by performing processing according to the programs stored in the program memory 1002.

FIG. 7 depicts a block diagram illustrating characteristic components in a video quantization parameter encoding device according to the present invention. As illustrated in FIG. 7, the video quantization parameter encoding device includes: a prediction unit 11 for generating a predicted quantization parameter from a past reconstructed quantization parameter; a computing unit 12 for generating a delta quantization parameter from a quantization parameter and the predicted quantization parameter (corresponding to a subtractor for subtracting the predicted quantization parameter PQP from the quantization parameter QP in FIG. 1, as an example); and a quantization parameter encoding unit 13 for generating an exponential Golomb bin string of a value obtained by converting the delta quantization parameter into an unsigned expression, adaptive binary arithmetic encoding a first bin of the exponential Golomb bin string, indicating whether the value of the unsigned expression of the delta quantization parameter is significant, and, when the first bin indicates that the value is significant, fixed binary arithmetic encoding other bins of the exponential Golomb bin string.

FIG. 8 depicts a block diagram illustrating characteristic components in a video quantization parameter decoding device according to the present invention. As illustrated in FIG. 8, the image quantization parameter decoding device according to the present invention includes a prediction unit 21 for generating a predicted quantization parameter from a past reconstructed quantization parameter and a quantization parameter decoding unit 22 for adaptive binary arithmetic decoding a first bin of an exponential Golomb bin string, indicating whether a value of an unsigned expression of a delta quantization parameter is significant, fixed binary arithmetic decoding other bins of the exponential Golomb bin string when the first bin indicates that the value is significant, and converting the unsigned expression of the decoded delta quantization parameter into a value of an original delta quantization parameter.

Though the present invention has been described with reference to the above exemplary embodiments and examples, the present invention is not limited to the above exemplary embodiments and examples. Various changes understandable by those skilled in the art can be made to the structures and details of the present invention within the scope of the present invention.

The present application claims priority based upon Japanese Patent Application No. 2012-145434, filed on Jun. 28, 2012, and the entire contents of which are incorporated herein by reference.

### REFERENCE SIGNS LIST

11 prediction unit
12 computing unit
13 quantization parameter encoding unit
21 prediction unit
22 quantization parameter decoding unit
101 predictor
102 buffer
1031 binarizer
104 adaptive binary arithmetic encoder
105 fixed binary arithmetic encoder
106 range determiner
111 switch
112 switch
201 predictor
202 buffer
2031 de-binarizer
204 adaptive binary arithmetic decoder
205 fixed binary arithmetic decoder
211 switch
212 switch

1. A video quantization parameter encoding method for encoding a quantization parameter for video encoding processing based on context-based adaptive binary arithmetic encoding, the method comprising:
generating a predicted quantization parameter from a past reconstructed quantization parameter;
generating a delta quantization parameter from a quantization parameter and the predicted quantization parameter;
generating an exponential Golomb bin string of a value obtained by converting the delta quantization parameter into an unsigned expression;
adaptive binary arithmetic encoding a first bin of the exponential Golomb bin string, indicating whether the value of the unsigned expression of the delta quantization parameter is significant; and
when the first bin indicates that the value is significant, fixed binary arithmetic encoding other bins of the exponential Golomb bin string.

2. A video quantization parameter decoding method for decoding a quantization parameter for video decoding processing based on context-based adaptive binary arithmetic encoding, the method comprising:
generating a predicted quantization parameter from a past reconstructed quantization parameter;
adaptive binary arithmetic decoding a first bin of an exponential Golomb bin string, indicating whether a value of an unsigned expression of a delta quantization parameter is significant;
fixed binary arithmetic decoding other bins of the exponential Golomb bin string when the first bin indicates that the value is significant; and
converting the unsigned expression of the decoded delta quantization parameter into a value of an original delta quantization parameter.

3. (canceled)

4. A video quantization parameter decoding device comprising:
a prediction unit for generating a predicted quantization parameter from a past reconstructed quantization parameter; and
a quantization parameter decoding unit which adaptive binary arithmetic decodes a first bin of an exponential Golomb bin string, indicating whether a value of an unsigned expression of a delta quantization parameter is significant, fixed binary arithmetic decodes other bins of the exponential Golomb bin string when the first bin indicates that the value is significant, and converts the unsigned expression of the decoded delta quantization parameter into a value of an original delta quantization parameter.

5. (canceled)

6. (canceled)
